(19) United States
(12) Patent Application Publication
(10) Pub. No.: US 2025/0349229 A1
(43) Pub. Date: Nov. 13, 2025

(54) BACKING PLATE FOR A HAZARDOUS MATERIAL PLACARD

(71) Applicant: International Name Plate Supplies Ltd., London (CA)

(72) Inventors: David Humann, London (CA); Thomas Freeman, St. Thomas (CA); Jason Jacyno, White Oak, TX (US); Donald Horvath, Murphy, TX (US)

(21) Appl. No.: 19/203,550

(22) Filed: May 9, 2025

(30) Foreign Application Priority Data
May 9, 2024 (CA) 3237965

(51) Int. Cl. G09F 7/14; G09F 7/08; G09F 23/00

(52) U.S. Cl. CPC G09F 7/14; G09F 7/08; G09F 23/00; G09F 2023/0025

(57) ABSTRACT

A backing plate for a hazardous material placard. The hazardous material placard comprises a hazardous material indicator that is a sequence of N characters indicating a type or limited class of hazardous material, N being a natural number. The backing plate is a metal plate having a size and shape approximately the same as the placard, and having N cutout portions that have been cut out from the backing plate corresponding to the sequence of N characters on the placard. The N cutout portions are positioned and sized so that the backing plate is positionable behind the placard so that the N cutout portions align with the N characters on the placard.

### FIELD OF THE INVENTION

The present invention relates generally to items used in conjunction with hazardous material placards and more particularly to backing plates for hazardous material placards.

### BACKGROUND OF THE INVENTION

Bulk containers transporting hazardous material (“HAZMAT”) are required to be placarded per the Department of Transportation (DOT) regulations in the United States. Similar rules apply in Canada and other countries.

Placards are a “diamond” shaped hazardous material information source for emergency responders, railroad employees and others. They are commonly referred to as being diamond shaped, which means that they are approximately square (a regular quadrilateral) but are displayed in a mounting position where one of the diagonals extending between two opposing vertices is vertical and the other diagonal is horizontal relative to the ground.

It is also possible that such a placard could be rectangular or another shape.

A hazardous material placard is normally approximately 10.8 inches (273 mm) by 10.8 inches (273 mm) but other sizes and shapes are possible.

Such placards are mounted on containers, such as a rail/tank car, containing hazardous material. The color of the placard indicates the major class of hazardous material inside the container. For example, red indicates flammable material and a combination of red and white indicates a flammable solid or spontaneously combustible.

Each placard normally has a hazardous material indicator, which is usually a United Nations (UN) four-digit number specifying the type of hazardous material in the container, ranging from 1001 (acetylene) to 9279 (hydrogen, absorbed in metal hydride).

The hazardous material indicator number may refer to a specific chemical or reflect a limited class of hazardous materials. For example, 1017 is only used for chlorine, 1005 has five chemical listings, 1993 is used for eight chemical listings and 2810 is used for 36 chemical listings.

In some cases, the hazardous material indicator is the actual name of the material such as CHLORINE or it may just identify the hazard, such as FLAMMABLE.

In any case, the number, name or other code identifying the hazardous material or hazard are oriented on a notional line parallel to the horizontal diagonal of the placard.

Such placards normally include a number in the bottom corner of the placard (towards the lower end of the vertical diagonal) that indicates the major class of the hazard and a graphical symbol located towards the upper end of the vertical access of the placard indicating the type of hazard, such as a skull and cross bones to indicate poisons. There are nine major classes of hazardous materials including class 2 for gases (flammable, nonflammable, inhalation hazard/poison, or oxygen) and 4 for flammable solids, spontaneously combustible, or dangerous when wet materials.

Placards are normally made of vinyl or other plastic material, tagboard or anodized aluminum. If the hazardous material burns, for example following an accident in which the container walls are ruptured, the placards attached to the container are likely to melt before first responders arrive at the scene so that the first responders are unable to be able to determine the type of hazardous material by looking at a placard. Plastic and tagboard placards will be destroyed at relatively low temperatures in the event of a fire that reaches such a placard. Aluminum melts at about 660° C., which is lower than most metals and it will melt at temperatures that can be encountered when hazardous material burns.

It would be desirable to provide a solution that would allow first responders to determine the hazardous material indicator and related information on a placard attached to a container while the hazardous material in the container is on fire.

### BRIEF DESCRIPTION OF THE DRAWINGS

FIG. 1 is a front view of a prior art hazardous material placard.

FIG. 2 is a front view of a prior art hazardous material placard mounting frame.

FIG. 3 is a front view of a prior art hazardous material placard behind a prior art hazardous material placard mounting frame.

FIG. 4 is a front view of an embodiment of a backing plate.

FIG. 5 is an exploded view of a backing plate and hazardous material placard in a mounting frame.

FIG. 6A is a side view of the backing plate and hazardous material placard of FIG. 5 partially inserted into the mounting frame.

FIG. 6B is a side view of the backing plate and hazardous material placard of FIG. 5 fully inserted into the mounting frame.

### DETAILED DESCRIPTION OF THE INVENTION

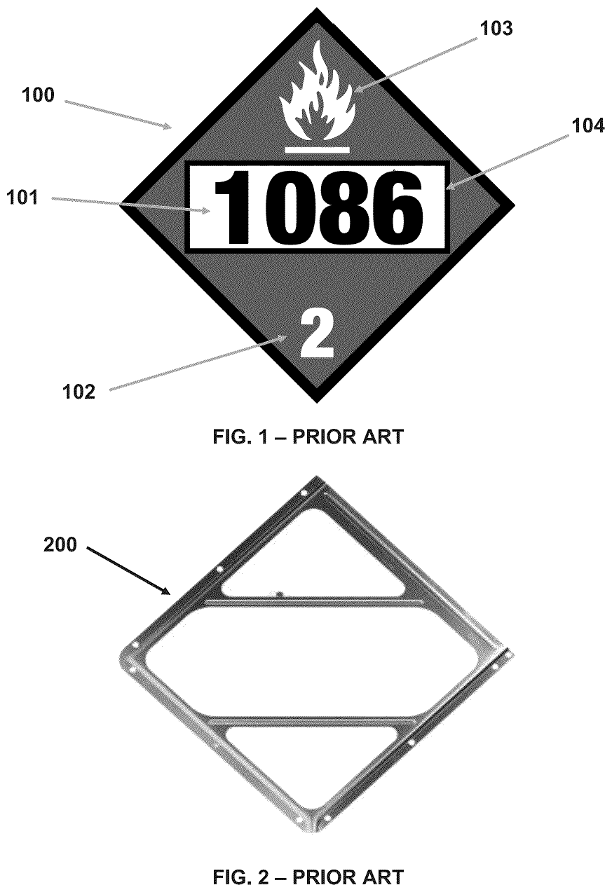

FIG. 1 shows a typical hazardous material placard 100 with a hazardous material indicator 101 that is the number 1086 which indicates VINYL CHLORIDE, STABILIZED, which is a flammable material. The placard 100 is predominantly red, indicating a flammable material. The placard 100 has a hazardous material class indicator 102 in the lower corner which is the number 2, indicating gas, and a hazard indicator 103 in the upper corner, which is a flame icon that indicates a flammable material. The four digits of the hazardous material indicator are black and are surrounded by a white rectangular region that provides contrast so that the hazardous material indicator is easily readable when the placard has not been melted or otherwise seriously damaged.

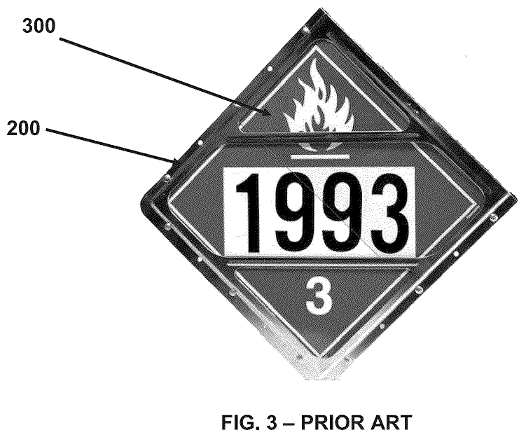

FIG. 2 shows a typical prior art frame 200 suitable for mounting the placard of FIG. 1 on a container. FIG. 3 shows a placard 300 in such a frame 200. The hazardous material indicator in the placard 300 of FIG. 3 is the number 1993 which indicates a limited class of various flammable liquids.

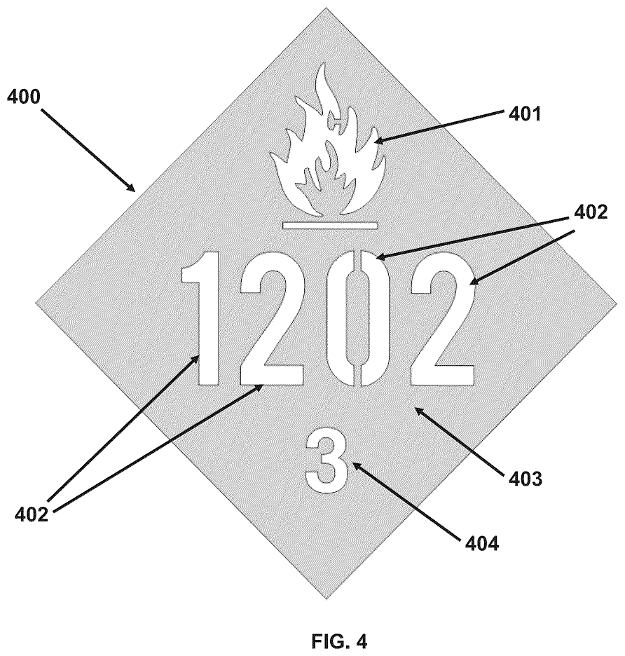

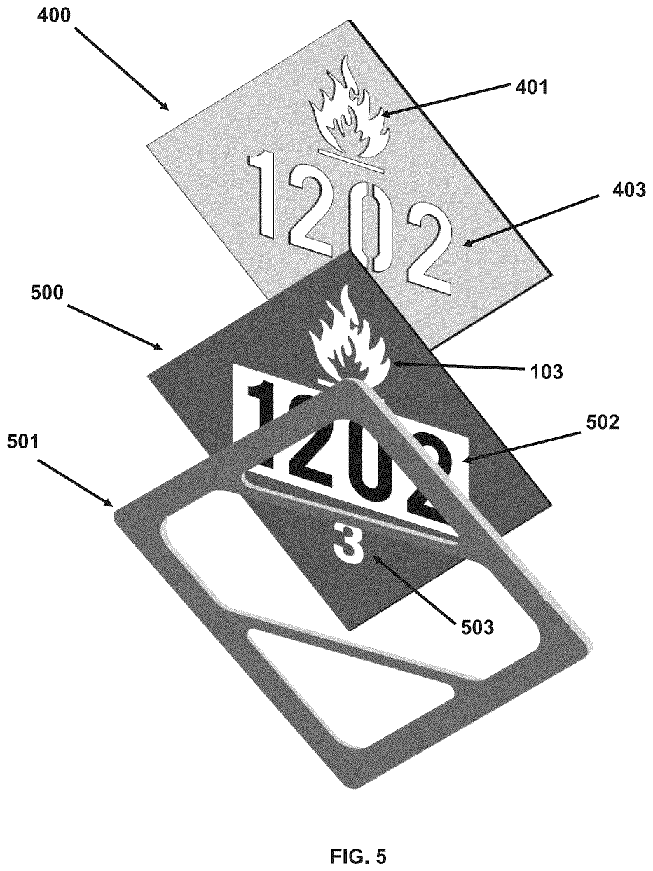

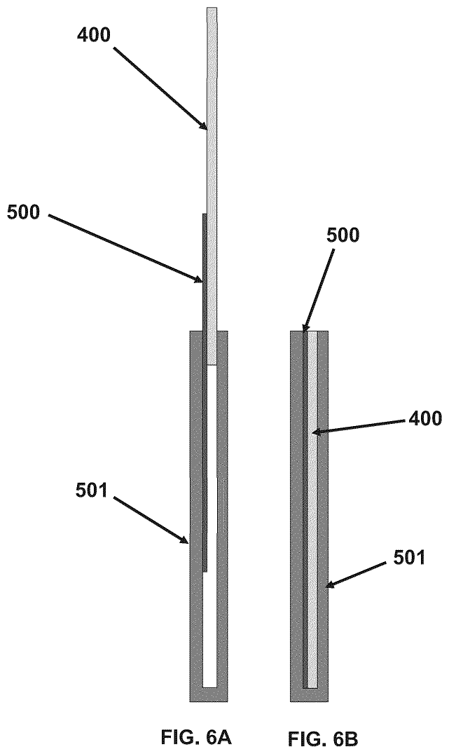

Some embodiments include a backing plate 400 for a hazardous material placard. A front view of a preferred embodiment is shown in FIG. 4. FIGS. 5, 6A and 6B show the backing plate 400 in combination with a placard 500 and a mounting frame 501.

Each instance of a backing plate is configured to be used in conjunction with a placard that designates a particular hazardous material. The backing plate 400 shown in FIGS. 4 and 5 is configured to be used with the placard 500 shown in FIG. 5 which has a hazardous material indicator 502 that is the number 1202, which indicates gas, oil, diesel fuel or heating oil, which are class 3 flammable liquids as indicated by the hazardous material class indicator 503. The placard 500 also has a hazard indicator 103 in the upper corner, which is a flame icon that indicates a flammable material.

In general, a hazardous material indicator is a sequence of N characters indicating a type or class of hazardous material, N being a natural number. This is often a four digit number as it is in the placard 500 shown in FIG. 5. The four digits are aligned along a notional line parallel to the horizontal diagonal of the placard 500 so that they are most easily readable when the placard 500 is mounted on a container with the vertical diagonal of the placard being approximately perpendicular to the ground, when the square placard 500 is often referred to as having a diamond shape.

The backing plate 400 of FIGS. 4 and 5 has approximately the same length and width as the placard 500 (which length and width are approximately equal as the placard and backing plate in this embodiment are square) and has three cutout portions. The central cutout portion 403 has four cutout sub-portions 402 that are the same size and shape as the digits of the hazardous material indicator 502 on the placard 500 and are located so as to align with the four digits in the hazardous material indicator of the placard 500 when the backing plate 400 is placed behind the placard 500, such as is shown in a side view in FIG. 6B, with the horizonal diagonals of the backing plate 400 and placard 500 approximately perpendicular to the ground.

Each cutout portion/sub-portion extends though the full depth of the backing plate 400 so that light, such as that produced by a fire behind the backing plate 400, is transmitted from behind the backing plate 400 through the cutouts in the backing plate 400 so that, if the placard 500 has melted or been otherwise removed, a viewer in front of the backing plate would see the cutout portions as illuminated by light from the fire behind the backing plate 400 and be able to determine the number of the hazardous material indicator 502 that was on the melted placard from the light passing through the hazardous material indicator cutout 403. Similarly the content of the hazard indicator 103 and hazardous material class indicator 503 can been determined based on light from a fire behind the backing plate 400 passing through the hazard indicator cutout 401 and the hazardous material class indicator cutout 404 respectively.

The backing plate 400 and placard 500 are aligned so than the cutouts in the backing plate 400 align with the information on the placard 500 and placed in a mounting frame, such as the frame 501 shown in FIGS. 5, 6A and 6B. The mounting plate is attached to a container, such as a rail car, that contains the material indicated by the hazardous material indicator 502 and which is in the hazardous material class the indicated in the hazardous material class indicator 503, and which poses the hazard indicated by the hazard indicator 103.

It is not essential that a backing plate include all three of a hazard indicator cutout 401, a hazardous material indicator cutout 403 and a material class indicator cutout 404. In some embodiments the backing plate only includes a hazardous material indicator cutout. In other embodiments the backing plate may include two of the three cutout portions.

It is not essential that the backing plate be the same size as the placard. In some embodiments the backing plate may be larger than the placard. In other embodiments the backing plate may be smaller than the placard. For example, the backing plate may be a rectangular metal plate having a length and width at least as large as the length and width, respectively, of a rectangular material indication portion of the rectangular material indication portion of the placard, for example the rectangular material indication portion 104 of the placard containing the hazardous material indicator 101.

The backing plate may be made of a metal with a relatively high meting point so that, as a minimum, it can survive longer, as the temperature of the placard and backing plate increase when the container is on fire, than placards that are made of plastic or tagboard, and preferably longer than aluminum placards. Preferred metals include galvanized steel, stainless steel and carbon steel.

What is claimed is:

1. A backing plate for a hazardous material placard, the hazardous material placard comprising a hazardous material indicator that is a sequence of N characters indicating a type or limited class of hazardous material, N being a natural number, the backing plate being a metal plate having a size and shape approximately the same as the placard, and having N cutout portions that have been cut out from the backing plate corresponding to the sequence of N characters on the placard, the N cutout portions being positioned and sized so that the backing plate is positionable behind the placard so that the N cutout portions align with the N characters on the placard.

2. The backing plate of claim 1, wherein N is equal to 4 and each character is a digit so that the hazardous material indicator is a four-digit number.

3. The backing plate of claim 1, wherein each character is a letter or and the sequence of letters forms a word that specifies the hazardous material.

4. The backing plate of claim 1, wherein the placard further comprises a hazard indicator that indicates the type of hazard associated with the hazardous material indicated by the hazardous material indicator, and the backing plate further comprises a hazard cutout portion corresponding to the hazard indicator being positioned and sized so that the backing plate is positionable behind the placard so that the hazard cutout portion aligns with the hazard indicator on the placard.

5. The backing plate of claim 1, wherein the backing plate is made of steel.

6. The backing plate of claim 5, wherein the backing plate is made of galvanized steel.

7. The backing plate of claim 5, wherein the backing plate is made of stainless steel.

8. A backing plate for a hazardous material placard, the hazardous material placard comprising a hazardous material indicator that is a sequence of N characters, N being a natural number, located in a rectangular material indication portion of the placard having a length and a width, the N characters forming a code indicating a type or class of hazardous material, the backing plate being a rectangular metal plate having a length and width at least as large as the length and width of the material indication portion respectively, and having N cutout portions that have been cut out from the backing plate corresponding to the sequence of N characters on the placard, the N cutout portions being positioned and sized so that the backing plate is positionable behind the placard so that the N cutout portions align with the N characters on the placard.

9. The backing plate of claim 8, wherein the code is a four-digit number.

10. The backing plate of claim 8, wherein the hazardous material placard and the backing plate are square with the code being oriented parallel to a first diagonal of the hazardous material placard to facilitate reading the code when the hazardous material placard is mounted on a container so that the first diagonal is horizontal and the other diagonal is vertical.

11. The backing plate of claim 9, wherein the hazardous material placard and the backing plate are square with the code being oriented parallel to a first diagonal of the hazardous material placard to facilitate reading the code when the hazardous material placard is mounted on a container so that the first diagonal is horizontal and the other diagonal is vertical.
